(19) United States
(12) Patent Application Publication
(10) Pub. No.: US 2008/0232341 A1
(43) Pub. Date: Sep. 25, 2008

(54) Scheduling for multi-carrier wireless data systems

(75) Inventors: Daniel Matthew Andrews, New Providence, NJ (US); Yihao Lisa Zhang, New Providence, NJ (US)

Correspondence Address: WEINICK & ASSOCIATES, LLC, 615 WEST MOUNT PLEASANT AVENUE, LIVINGSTON, NJ, 07039, US

(73) Assignee: Lucent Technologies Inc.

(21) Appl. No.: 11/725,249

(22) Filed: Mar. 19, 2007

(51) Int. Cl. H04J 3/00

(52) U.S. Cl. 370/345

(57) ABSTRACT

Disclosed is a method and apparatus for scheduling multiple carriers to service multiple users in a multi-carrier wireless data network. A data transmission in a multi-carrier wireless data system can be scheduled in frames comprising one or more time slots. For each frame, each of multiple carriers in each time slot of the frame are assigned to one of multiple users. Various objective functions can be used to assign the carriers to the users based on a weight for each user and a channel rate of each carrier for each user while preventing excessive carriers from being assigned to a user.

### BACKGROUND OF THE INVENTION

The present invention is generally directed to scheduling in wireless data systems.

Wireless data systems are used to transmit data between a base station and multiple user devices. For convenience, user devices capable of wirelessly communicating with a base station in a wireless data system will be referred to as “users” herein. In a wireless data system, a base station transmits data to a user via a wireless carrier having a predetermined frequency or range or set of frequencies to transmit the data to the user. The rate of data transmission is dependent on which user is receiving the data, the carrier used to transmit the data, and the time at which the data is transmitted. In some wireless communication systems, the carrier is assigned to transmit data to a particular user in a time slot. At each time slot, a scheduler in the base station assigns the carrier to one user, and the carrier transmits data to that user in the time slot.

A large body of work has been devoted to addressing the problem of scheduling time slots in multi-user systems over time-varying and user dependent channels. For example, the finite-queue model aims to keep the system stable by assuming that the queues are fed by arrival processes not controlled by the model. One such finite-queue model is based on the well-known MaxWeight algorithm. Alternatively, the infinitely-backlogged model aims to maximize the system utility in assuming the queues are permanently backlogged. Other work examines the difference between models where the channel rates are governed by some stationary stochastic process and models where a worst-case adversarial channel process is assumed. However, these conventional scheduling methods address situations in which scheduling decisions are made for a single wireless carrier on a time slot by time slot basis.

Some wireless systems have multiple carriers which can be assigned to different users concurrently. Examples of such multi-carrier systems include a multi-carrier CDMA-1xEVDO system that utilizes multiple CDMA carriers and the 802.16 Wimax standard that uses an OFDMA (Orthogonal Frequency Division Multiple Access) physical layer in which different “tones” can be assigned to different users at each time. Another difference between Wimax and conventional signal carrier systems is that each time slot cannot be scheduled in isolation. In the Wimax standard, time is divided into frames of multiple time slots, and an entire frame must be populated (assigned to users) whenever a previous frame ends.

One possible approach to scheduling multiple carriers is to schedule carriers independently from each other using a conventional single carrier scheduling algorithm for each single carrier. However, it is unclear if the performance of a conventional single carrier scheduling algorithm can be directly translated from a single-carrier system to a multi-carrier system. For example, all carriers could favor the same user which would lead to an excessive amount of service to one user. Accordingly, improved scheduling methods for multi-carrier and frame-based data systems are desirable.

### BRIEF SUMMARY OF THE INVENTION

Embodiments of the present invention provide scheduling methods for multi-carrier wireless data systems. The embodiments of the present invention can be used in frame-based and non-frame based wireless data systems in which multiple carriers are used to transmit data to multiple users.

According to an embodiment of the present invention, a multi-carrier wireless data system is scheduled in frames comprising one or more time slots. For each frame, each of multiple carriers in each time slot of the frame are assigned to one of multiple users. An objective function may be used to assign the carriers to the users based on a weight for each user and a channel rate of each carrier for each user while preventing excessive carriers from being assigned to a user. For example, the carriers can be sequentially assigned to the users based on an objective function which takes into account an adjusted value of a queue size of a user based on an assignment of a carrier to that user. It is also possible that the users can be sequentially assigned carriers to provide service the users based on an objective function which compares the benefits of carriers being assigned to each user. It is also possible that the scheduling is performed globally by simultaneously assigning a set of carriers to each user.

According to another embodiment, the present invention can be used for template scheduling in multi-carrier wireless data systems. Once each carrier in each time slot of a frame is assigned to a user, the carriers assigned to each user are redistributed over the time slots in the frame to smooth service to each user over the frame. Thus, the frame can be used as a template for template based scheduling.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary multi-carrier wireless data system;

FIG. 2 illustrates a frame-based multi-carrier schedule;

FIG. 3 illustrates a method of transmitting data to multiple users according to an embodiment of the present invention;

FIG. 4 illustrates a method for assigning multiple carriers to multiple users according to a first embodiment of the present invention;

FIG. 5 illustrates a method for assigning multiple carriers to multiple users according to a second embodiment of the present invention;

FIG. 6 illustrates a method for assigning multiple carriers to multiple users according to a third embodiment of the present invention;

FIG. 7 illustrates a method for assigning multiple carriers to multiple users according to a fourth embodiment of the present invention;

FIG. 8 illustrates a method for smoothing service scheduled in a template according to an embodiment of the present invention; and

FIG. 9 is a high level block diagram of a computer capable of implementing various embodiments of the present invention.

### DETAILED DESCRIPTION OF THE INVENTION

Embodiments of the present invention are directed to scheduling data transmission in a multi-carrier wireless data network. FIG. 1 illustrates an exemplary multi-carrier wireless data network 100. As illustrated in FIG. 1, a base station 102 transmits data to a set of N wireless users 104. The base station 102 can transmit the data to the users 104 on a set of C carriers 106. At each time slot, multiple ones of the carriers 106 can be assigned to the same one of the users 104. However, at any one time, each one of the carriers 106 can be assigned to at most one of the users 104.

The indicator variable x(i,c,t) is used herein to indicate whether or not carrier c is assigned to user i at time t. For example, x(i,c,t) is equal to 1 if carrier c is assigned to user i at time t, and equal to 0 if carrier c is not assigned to user i at time t. When a carrier is assigned to user, the carrier acts as a wireless channel for transmitting data to the user. Due to the wireless nature of the channel, the channel rate (i.e., the data transmission rate of the wireless channel) depends on which user the carrier is assigned to and the time slot. The channel rate can also depend on the carrier, since the radio propagation environment may be different for different carriers, e.g., when carriers are on different frequencies. Accordingly, r(i,c,t) is used herein to denote the channel rate of carrier c for user i at time step t. If x(i,c,t)=1 for carrier c, then data of size r(i,c,t) can be transmitted to user i at time t on carrier c. The size of the data can be expressed in bits, bytes, or any other unit which relates to the size of digital information. Similarly, the channel rate is expressed as an amount of data, which is the amount of data the can be transmitted in one time slot. The channel rates of all of the carriers for each user is known by a scheduler (for example, in a base station) when scheduling a time slot or a frame. In order to schedule data transmission in a wireless data system the values of x(i,c,t) are determined for each carrier c for each user i at each time slot t.

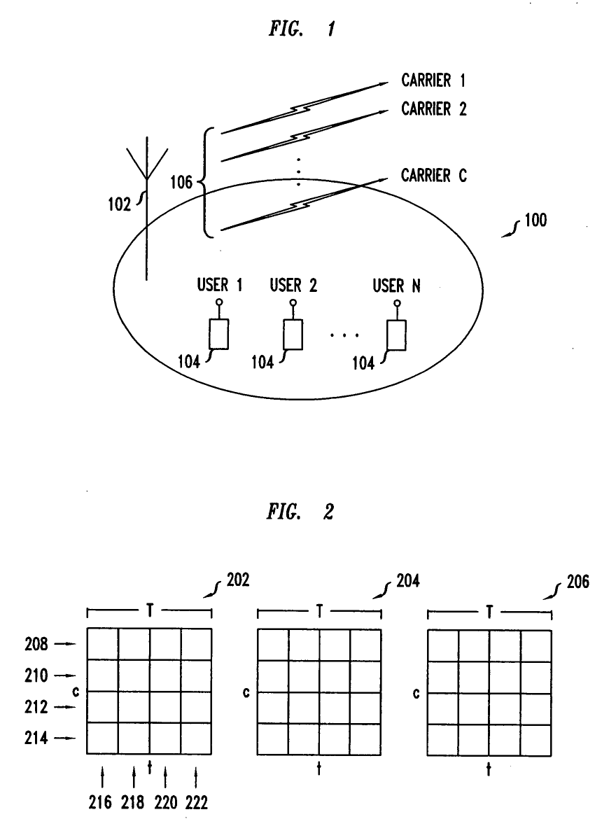

In frame-based wireless data systems, such as the 802.16 Wimax standard, time is divided into frames. FIG. 2 illustrates frame-based multi-carrier scheduling. As illustrated in FIG. 2, each frame 202, 204, and 206 is used to schedule users for multiple carriers over multiple time slots. For example, in frame 202 of FIG. 2, users must be scheduled for carriers 208, 210, 212, and 214, at time slots 216, 218, 220, and 222. Each (time slot, carrier) pair is referred to as a “tile” herein. Each carrier at each time slot (i.e., each tile) is assigned to a user. As illustrated in FIG. 2, each of the frames 202, 204, and 206 have the same length (in time) T. Accordingly, the time interval [kT, (k+1)T) defines one such frame. For a frame defined by [kT, (k+1)T), the schedule for the entire frame is determined at time kT (the beginning of the frame). Since the true channel rate of a time slot is unknown until the time slot occurs, scheduling decisions made for a frame are based on channel rates at the beginning of the frame. This can be expressed as r(i,c,t)=r(c,kT) for all tε[kT, (k+1)T). The scheduling methods of the various embodiments are described using a frame size of one time slot. Accordingly, these methods are applicable to non-frame based multi-carrier wireless data systems as well as frame based systems, since non-frame based systems can be assumed to have a frame size of one time slot. These scheduling methods can be used with larger frames (with disjoint fixed-size multiple time slots) by treating each such (fixed size multiple time slot, carrier) pair as a separate scheduling unit.

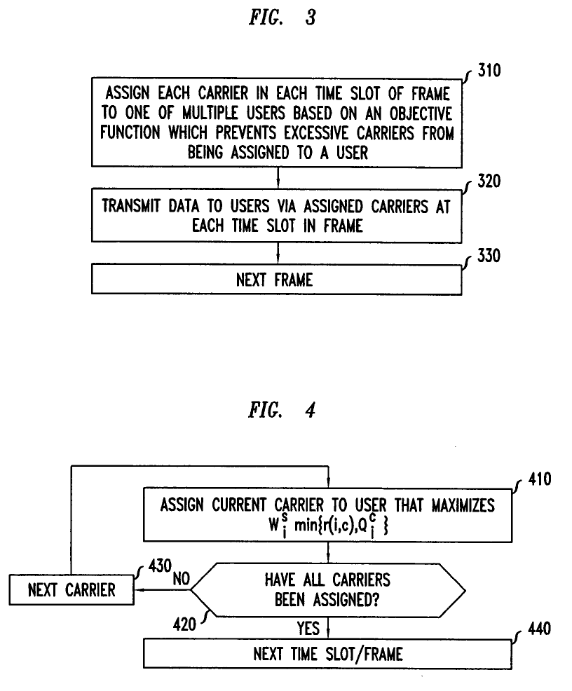

FIG. 3 illustrates a method of transmitting data to multiple users according to an embodiment of the present invention. At step 310, each carrier in each time slot of a frame is assigned to one of multiple users based on an objective function. Herein, frame means a sequence of one or more neighboring time slots. As used herein, a (time slot, carrier pair) is referred to as “scheduling unit”. The objective function is based on a weight of the user and the channel rate of the carrier for the user, and prevents excessive carriers from being assigned to a user. Various objective function, according to various embodiments of the present invention are described in detail below. The weight of a user can be, e.g., a queue size of the user, or some function of the queue size of the user. Various objective functions for assigning the carriers to the users according to various embodiments of the present invention are described below. At step 320, data is transmitted to various users at each time slot in the frame via the assigned carriers. At step 330, the method involves looping back to process the next frame to be scheduled. Thus, the method returns to step 310 to assign each carrier in each time slot of the next frame to one of the multiple users.

In order to select an objective function for assigning the carriers to the users, it is possible to consider a finite-queue model with an external arrival process. In this model, let aᵢ(t) be the amount of data that arrives for user i in time slot t. One objective is to keep the system stable, i.e., keep user queues bounded, whenever possible. In the single carrier situation, the well-known MaxWeight algorithm always serves the user that maximizes Wᵢ^{s}(t)r(i,t) at each time slot t. Here, Wᵢⁱs(t) denotes a weight for user i at the beginning of time slot t. In a particular implementation of the MaxWeight algorithm, this weight can be the queue size Qᵢ^{s}(t) of the user i at the beginning of time slot t. The weight can be the queue size of the user, as well as a function of other attributes of the user, including but not limited to, an average service rate that the user has recently received, a delay of the data in the user's queue, or some type of “virtual queue” that measures whether some minimum rate requirements are being met for the user. The MaxWeight algorithm for single carrier situations is described in greater detail by L. Tassiulas et al., in “Stability Properties of Constrained Queuing Systems and Scheduling Policies for Maximum Throughput in Multihop Radio Networks.” IEEE Transactions on Automatic Control, 37(12):1936-1948, December 1992, which is incorporated herein by reference in its entirety.

The MaxWeight algorithm is known to be stable for single carrier situations. Since the MaxWeight algorithm is stable in the single carrier system, it is possible to emulate the MaxWeight algorithm in multi-carrier wireless data systems. Let μ(i,t)=Σ_{c}r(i,c,t)x(i,c,t) be the amount of service user i receives at time t. One possible objective function to emulate the MaxWeight algorithm for multi-carrier systems is:

$$max {\sum }_{i} {W}_{i}^{s} ( t ) μ ( i , t ) . \qquad Objective ( 1 )$$

Objective (1) is one possible analogue of the MaxWeight algorithm which maximizes ΣᵢWᵢ^{s}(t)r(i,t)x(i,t) for the single carrier case. Objective (1) can be optimized by assigning each carrier to the user that maximizes Wᵢ^{s}(t)r(i,c,t). Accordingly, optimizing Objective (1) is the equivalent of independently performing the MaxWeight algorithm for a single carrier system to each carrier of a time slot (or each time slot, carrier pair of a frame). Since this objective does not take into account the effect of other carriers when assigning a carrier to a user, this objective has a potential shortcoming of assigning more service (i.e., carriers) to a user than is necessary for that user. As used herein, a carrier is considered to be “excessive” with respect to a user at a time slot if the user already has enough carriers assigned to that user in that time slot to service all of the data in the queue of the user. The problem of Objective (1) assigning excessive carriers to a user is particularly pronounced when queue sizes are small. Although this effect does not change the stability properties of the MaxWeight algorithm, it can lead to much larger queue sizes which can result in packet delays.

Objective functions (2) and (3) below show possible objectives which can be used to optimize scheduling in multi-carrier wireless data systems by methods that prevent excessive carriers from being assigned to a user:

$$\begin{matrix}max {\sum }_{i} {W}_{i}^{s} ( t ) min \{ {Q}_{i}^{s} ( t ) , μ ( i , t ) \} ; & Objective ( 2 ) \\ max {\sum }_{i} {( {W}_{i}^{s} ( t ) )}^{2} - {( {W}_{i}^{e} ( t ) )}^{2} . & Objective ( 3 )\end{matrix}$$

Objective function (2) maximizes the sum for all users of the product of the weight of user and the minimum of the amount of service given to the user and the queue size of the user. Objective function (3) maximizes the sum for all users of the weight of the user at the start of the time slot squared and the weight of the user at the end of the time slot squared.

Objective (2) replaces μ(i,t) in Objective (1) with min{Qᵢ^{s}(t),μ(i,t)}. Thus, in situations in which the queue size of a user is larger than the amount of service a user would receive if a particular carrier is assigned to that user, the carrier will not be assigned to the user if the carrier can instead be assigned to another user with a queue size greater than or equal to the amount of service the other user would receive if the carrier were assigned to the other user. Objective (3) explicitly maximizes the negative drift of the Lyapunov function, where Wᵢ^{s} denotes the queue size of user i at the beginning of time slot t, and Wᵢ^{e} denotes the weight of user i at the end of time slot t. Accordingly, Objective (3) prefers assignments of carriers which would maximize the difference between the weight of a user at the beginning of the time slot and the end of the time slot. Thus, this objective prevents the assignment of a carrier whose weight will not be substantially changed by the service provided by that carrier.

Both Objectives (2) and (3) are more sensitive to maintaining small queues than Objective (1). However, both Objectives (2) and (3) are NP-hard to optimize, and hence, no known algorithm can efficiently find and optimal solution for moderate size systems. Furthermore, they cannot be approximately optimized to within a factor of 1−δ for some constant δ. These two objectives are related in that any α-approximation for Objective (2) is a α/2-approximation for Objective (3). A α-approximation algorithm for an NP-hard problem is an efficient algorithm that produces a solution that is always within a factor of a of an optimal solution to the NP-hard problem

FIGS. 4-7 illustrate various methods for approximating Objectives (2) and (3). Accordingly, FIGS. 4-7 illustrate methods for assigning multiple scheduling units (i.e., time, carrier pairs) to multiple users in a particular time slot or frame (step 310 of FIG. 3) according to various embodiments of the present invention. Each of these methods assigns each of the multiple scheduling units for a frame or a time slot to one of multiple users. For a single time slot (i.e., a frame having a single time slot), each carrier is a single scheduling unit. For a frame having multiple time slots each (time slot, carrier) pair is a scheduling unit. In the discussion of the following algorithms, the following notation is utilized. Since each method assigns the scheduling units to users within a time slot (or frame), the dependence on t is omitted in the following notation for convenience.
Wᵢ^{s}=weight for user i at the beginning of time slot t which includes the arrival aᵢ(t) for time slot t.
Qᵢ^{s}=queue size for user i at the beginning of time slot t which includes the arrival aᵢ(t) for time slot t.
Wᵢ^{e}=weight for user i at the end of time slot t.
Qᵢ^{e}=queue size for user i at the end of time slot t.
r(i,c)=rate for user i, carrier c at time slot t.
μᵢ=total service to user i during time slot t.
Wᵢ^{c}=weight for user i after carrier c has served used i.
Qᵢ^{c}=queue size for user i after carrier c has served used i

Two equations that relate the above quantities are:

Qᵢ^{c+1}=max{0,Qᵢ^{c}−r(i,c)}

Qᵢ^{e}=max{0,Qᵢ^{s}−μᵢ}

FIG. 4 illustrates a method for assigning multiple scheduling units to multiple users according to a first embodiment of the present invention. This method gives a ½-approximation for Objective (2). Accordingly, the resulting solution (assignment of scheduling units to users) from this method will always be within a factor of 2 of the optimal solution for Objective (2). This method sequentially assigns each of the multiple scheduling units to one of the multiple users.

At step 410, the method involves assigning a current scheduling unit to a user î that maximizes Wᵢ^{s} min{r(i, c),Qᵢ^{c}}. This maximization step can be performed by a computer device solving for î using the equation, î=arg max₁Wᵢ^{s} min{r(i, c,Qᵢ^{c}}. Accordingly, this method selects a user for the current scheduling unit based on the weight of the user at the beginning of the time slot and the channel rate of the user and the carrier. However, this method does not consider the channel rate in situations when the queue size of the user will be less than the channel rate if the current carrier is used to service the user.

At step 420, the method involves determining whether all of the scheduling units have been assigned to a user. If any scheduling units have not been assigned to a user, the method proceeds to step 430. If all of the scheduling units have been assigned to a user the method proceeds to step 440. At step 430, the method involves selecting a next scheduling unit and looping back to step 410 to process the next scheduling unit in order to assign the next scheduling unit to a user. As defined above, Qᵢ^{c+1}=max{0,Qᵢ^{c}−r(i,c)}. Accordingly, this method takes into account the effect of the previously assigned scheduling units on the queues of the users to which the previously assigned scheduling units are assigned. At step 440, when all of the scheduling units are assigned, the scheduling for the time slot is complete and the method can include repeating the above steps for a next time slot or frame.

FIG. 5 illustrates a method for assigning multiple scheduling units to multiple users according to a second embodiment of the present invention. This method gives a ⅓-approximation for Objective (3). Accordingly, the resulting solution (assignment of scheduling units to users) from this method will always be within a factor of 3 of the optimum solution for Objective (3). This method sequentially assigns each of the multiple scheduling units to one of the multiple users.

At step 510, the method involves assigning a current scheduling unit to a user î that maximizes Wᵢ^{c} min{r(i,c),Qᵢ^{c}}. This assignment step can performed computer device solving for î using the equation, î=arg maxᵢWᵢ^{c} min{r(i,c),Qᵢ^{c}}. Accordingly, this step involves selecting a user for the current scheduling unit based on the projected weight for the user after the current scheduling unit services the user, and the channel rate of the user and the carrier. However, this step does not consider the channel rate in situations when the queue size of the user will be less than the channel rate if the current scheduling unit is used to service the user.

At step 520, the method involves determining whether all of the carriers have been assigned to a user. If any carriers have not been assigned to a user, the method involves performing step 530. If all of the carriers have been assigned to a user the method involves performing step 540. At step 530, the method involves selecting a next scheduling unit and looping back to step 510 to process the next scheduling unit in order to assign the next scheduling unit to a user. As defined above, Qᵢ^{c+1}=max {0,Qᵢ^{c}−r(i,c)}. Accordingly, this method takes into account the effect of the previously assigned scheduling units on the queues of the users to which the previously assigned scheduling units are assigned. If the weight of a user is a function of the queue size of that user, then Wᵢ^{c+1} is determined based Qᵢ^{c+1} for each user. At step 540, when all of the scheduling units are assigned, the scheduling for the time slot or frame is complete and the method can include looping back to repeat the above steps for a next time slot or frame.

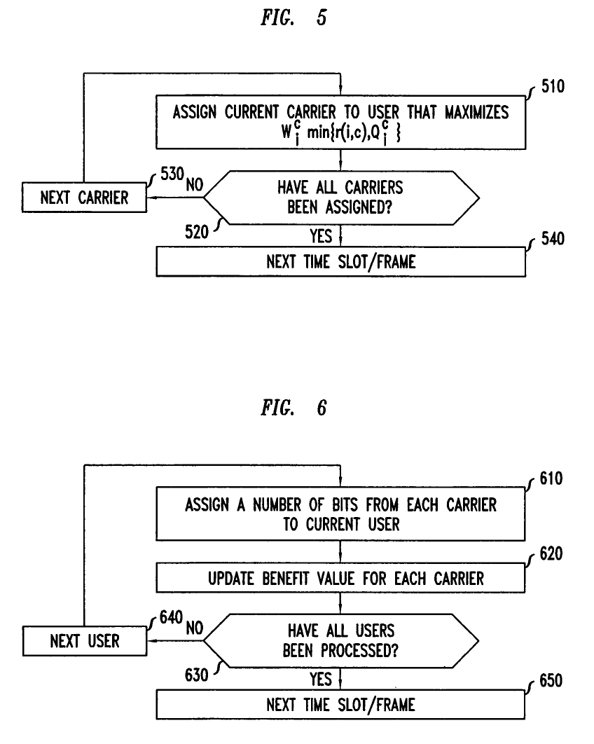

FIG. 6 illustrates a method for assigning multiple scheduling units to multiple users according to a third embodiment of the present invention. This method gives a ½-approximation for Objective (2). Accordingly, the resulting solution (assignment of scheduling units to users) from this method will always be within a factor of 2 of the optimum solution for Objective (2). This method considers each of the multiple users one by one and determines the best scheduling unit(s) for each user. However, the assignment of a scheduling unit to a user can be modified if there is greater benefit for a scheduling unit to serve a later considered user.

At step 610, the method involves assigning a number of bits b(i,c) from each scheduling unit to a current user. For a user i, the assigned bits b(i,c) from each scheduling unit are determined based on the objective function:

$$max {\sum }_{c} ( max \{ 0 , {W}_{i}^{s} b ( i , c ) - β ( c ) \} )$$

$$s . t . \\ b ( i , c ) \leq r ( i , c ) ∀ i , c$$

$${\sum }_{c} b ( i , c ) \leq {Q}_{i}^{s} ∀ i$$

where β(c) is a benefit value for a scheduling unit that measures the best allocation so far for the scheduling unit. The benefit value β(c) of scheduling unit c assigned to a user i is equal to the product of the queue size of the user Qᵢ^{s} and the number of bits b(i,c) from the scheduling unit c assigned to the user i. Thus, this equation compares the possible benefit of assigning a number of bits from a scheduling unit to the current user (Wᵢ^{s}b(i,c)) with the benefit value β(c) of the best allocation for the scheduling unit so far. Accordingly, a current user can be assigned a scheduling unit to transfer a certain number of bits of data if the assignment of the scheduling unit to the current user has a greater benefit than a previous assignment of the scheduling unit to another user. The constraints in the above objective function ensure that the number of bits from a scheduling unit assigned to a user cannot be greater the channel rate for the carrier and the user, and that the total number of bits assigned to a user from all of the scheduling units are not greater than the amount of data in the queue of the user at the start of the time slot. Such constraints ensure that excess carriers are not assigned to the current user.

At step 620, the method involves updating the benefit value β(c) for each scheduling unit to take into account the number of bits b(i,c) from each scheduling unit that are allocated to the current user. At this step, the benefit value β(c) for the scheduling unit c is updated, e.g., by the replacement β(c)←max{β(c), Wᵢ^{s}b(i,c)}. Thus, if a scheduling unit is assigned to the current user based on the above objective function, the benefit value for that scheduling unit is updated to be Wᵢ^{s}b(i,c) at this step. If a carrier is not assigned to the current user, at this step, the carrier maintains the same benefit value β(c), which is a measure of the best previous allocation of that carrier.

At step 630, the method involves determining whether each user has been processed. If any user has not yet been processed, the method proceeds to loops back 640 to consider the next user. If all of the users have been processed, the method proceeds to step 650. At step 640, the method involves proceeding to a next user and returns to step 610 to assign carriers for the next user. At step 650, when all of the users have been processed, the scheduling for the time slot is complete and the method can be repeated for a next time slot or frame.

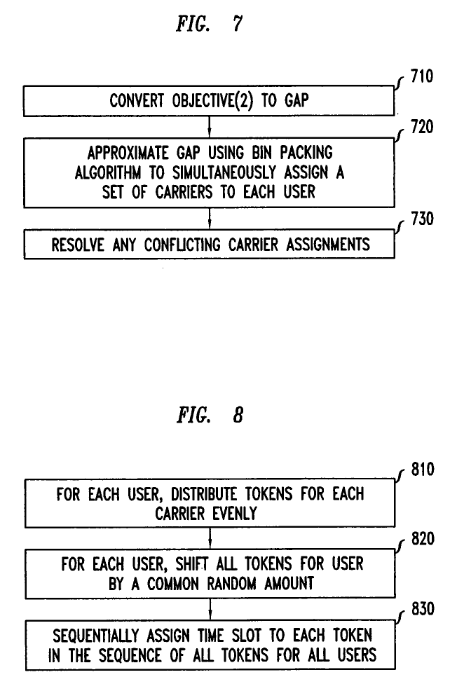

FIG. 7 illustrates a method for assigning multiple carriers to multiple users according to a fourth embodiment of the present invention. This method gives a (1−1/e)-approximation for Objective (2). This method approaches the multi-carrier scheduling problem as a global problem and simultaneously assigns each of the multiple carriers to one of the multiple users.

At step 710, Objective (2) is converted into a General Assignment Problem (GAP). The GAP is a bin packing problem in which a set of items and a set of bins of different sizes are given. Each item has a bin-dependent profit and a bin-dependent size. The goal of the GAP is to pack the items into the bins so as to maximize profit and such that no bin-size is violated. Step 710 can be performed by a computer device as follows. This conversion step may be performed on a computer device once and stored, such that steps 720 and 730 may be performed using the stored GAP without repeating step 710. In order to convert Objective (2) to a GAP, let Λᵢ be the set of all possible subsets of scheduling units that could be assigned to user i. For SεΛᵢ let fᵢ^{s}=Wᵢ^{s}min{Σ_{CεS}r(i,c),Qᵢ^{s}}. The variable Xᵢ^{S} is used to indicate whether or not subset S is assigned to user i. The solution to the following integer linear program optimizes Objective (2):

$$max {\sum }_{i , S ∈ {Λ}_{i}} {f}_{i}^{S} {X}_{i}^{S}$$

$$s . t . \\ {\sum }_{i ∈ U , S ∈ {Λ}_{i} : c ∈ S} {X}_{i}^{S} \leq 1 ∀ c$$

$${\sum }_{S ∈ {Λ}_{i}} {X}_{i}^{S} \leq 1 ∀ i$$

$${X}_{i}^{S} ∈ \{ 0 , 1 \} .$$

At step 720, the method involves approximating the GAP using a bin packing algorithm to simultaneously assign a set of one or more scheduling units to each user. One such bin packing algorithm is described in greater detail by L. Fleischer et al., “Tight Approximation Algorithms for Maximum General Assembly Problems.” In Proceedings of the 17th Annual ACM-SIAM Symposium on Discrete Algorithms, pages 611-620, 2006, which is incorporated herein by reference in its entirety. In order to approximate the GAP using the bin packing algorithm, the step 720 may involve determining an approximation solution for the linear relaxation of the above integer linear program in which the constraint Xᵢ^{S}ε{0,1} is replaced by Xᵢ^{S}ε[0,1]. It can be noted that even this linear relaxation is not optimally solvable. The algorithm thus, may round the solution by assigning the set S to the user i with probability x_{S}ⁱ. However, this may result in one or more of the scheduling units being assigned to more than one user. Thus, at step 730, the method involves resolving any such conflicting scheduling unit assignments. In order to resolve conflicting scheduling unit assignments, method may involve selecting one among the assignments for each scheduling unit assigned to more than one user such that the selected one of the assignments gives the maximum benefit in terms of Objective (2).

The above described embodiments provide various scheduling methods for multi-carrier wireless data systems. These scheduling methods can be used for frame-based scheduling in multi-carrier wireless data systems. In some frame-based systems, such as 802.16 (Wimax), template based scheduling is used, in which a scheduled frame is used as a template and repeated in order to deliver data to users. In such systems, it may be desirable to provide a constant bit rate to users, and the data rate provided to each user should be as “smooth” as possible. Accordingly, given a template comprising T time slots, it is desirable to assign (time slot, carrier) pairs within the template such that the total amount of service assigned to each user matches the user's requested rate, and the service allocated to each user is spaced out so that the user does not receive data in bursts.

Since the constant bit rate requirement is typical for users with low mobility, it is possible to assume the channel rate for a (user, carrier) pair is constant over a period longer than the template size. Therefore, the template schedule can be repeated to provide a constant bit rate over long periods. However, due to different radio environments at different frequencies, the channel rates can be different on different carriers. Thus, the template scheduling problem for multiple-carrier data systems can be divided into two parts. First, it is determined how many time slots need to be allocated to each user on each channel in order to satisfy the requested service rates of the users. This is performed using the multi-carrier scheduling algorithms discussed above. Next, it is determined which time slots within the template to allocate each user on each channel so as to optimize the smoothness of the schedule. The smoothness of a schedule for a user can be formally defined as the maximum, over any time interval, of the difference between the amount of service allocated by the schedule and the amount of service allocated by a schedule that gives a constant amount of service for the user in each time slot.

FIG. 8 illustrates a method for smoothing service scheduled in a template according to an embodiment of the present invention. For a user i, f_{i,c} is the number of time slots allocated to the user i on carrier c. Tokens are a set of markers (one for each time slot) that are arranged within a time interval whose length is equal to the frame length. The order of the tokens defines the schedule. The number of tokens for user i on carrier c is f_{i,c} (one token for each time slot allocated to the user i on carrier c). At step 810, for each user, tokens for each carrier are evenly distributed. For example, for a user i, carrier c tokens are distributed every 1/f_{i,c} steps.

At step 820, for each user, all of the tokens for that user are shifted by a common random amount. This results in all of the tokens for all of the users being organized into a sequence. The tokens for each user are shifted by an amount chosen uniformly at random from the interval [0, frame length]. For each user, the random amount of the shift for each of the tokens of the user is the same. However, the random amounts of the shift for different users are chosen independently.

At step 830, each token in the sequence of all of the tokens for all of the users is sequentially assigned a time slot. Thus, the sequence of tokens determines the order in which the time slots for each carrier are assigned. Since each user's tokens for each carrier are distributed evenly and then randomly shifted, the amount of service a user receives in each subportion of the template will be roughly the same, thus ensuring the smoothness of the service for each user.

In addition to the method described in FIG. 8, it is also possible to apply well-known single carrier smoothing methods for template scheduling to the multiple carrier system by independently applying such smoothing methods to each carrier. For example, the well-known bipartite matching algorithm can be independently applied in each carrier of a template to smooth the service provided by each carrier. Similarly, the well-known Golden Ratio algorithm can be applied in each carrier of a template to smooth service provided by each carrier. The Golden ratio algorithm for single carrier situations is described in greater detail by M. Hofri et al., in “Packet Delay Under the Golden Ratio Weighted TDM Policy in a Multiple Access Channel.” IEEE Transactions on Information Theory, 33:341-349, 1987.

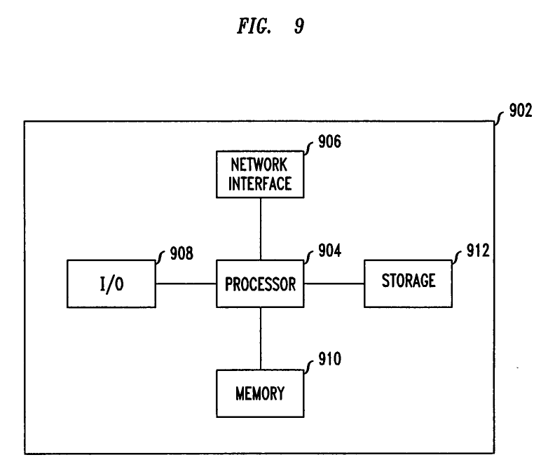

According to various embodiments of the present invention, one or more of the above described methods may be implemented on appropriately configured computers, for example, using well known computer processors, memory units, storage devices, computer software, and other components. A high level block diagram of such a computer is shown in FIG. 9. Computer 902 contains a processor 904 which controls the operation of computer 902 by executing computer program instructions which define such operation. The computer program instructions may be stored in a storage device 912 (e.g., magnetic or optical disk or a hard drive) and loaded into memory 910 when execution of the computer program instructions is desired. It is also possible that processor 904 is a programmable processor, such as a DSP chip, an ARM processor, etc., programmed with computer program instructions for implementing the above-described methods. Computer 902 also includes one or more network interfaces 906 for communicating with other devices via a network. Computer 902 also includes input/output 408 which represents devices which allow for user interaction with the computer 902 (e.g., display, keyboard, mouse, speakers, buttons, etc.). One skilled in the art will recognize that an implementation of an actual computer will contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operating a multi-carrier wireless data system for scheduling wireless data in a frame comprising one or more time slots, comprising:
assigning each of a plurality of carriers in each time slot of the frame to one of a plurality of users based on a weight for each user and one or more per-carrier channel rates of each user.

2. The method of claim 1, wherein the weight of one of the users is the queue size of the one of the users

3. The method of claim 1, wherein said step of assigning each of a plurality of carriers in each time slot of the frame to one of a plurality of users involves optimizing an objective function.

4. The method of claim 3, wherein said step of assigning each of a plurality of carriers in each time slot of the frame to one of a plurality of users comprises:
assigning each of the plurality of carriers in each time slot of the frame to one of the plurality of users such that the carriers assigned to each of the plurality of users are not excessive with respect to a queue size of the user.

5. The method of claim 3, wherein said step of assigning each of a plurality of carriers in each time slot of the frame to one of a plurality of users comprises:
sequentially assigning each of the plurality of carriers in each time slot to one of the plurality of users, such that each of the plurality of carriers is assigned to a user for which the objective function is maximum, wherein said objective function is based at least in part on an adjusted value of a queue size of a user based on an assignment of a carrier to that user.

6. The method of claim 5, wherein said step of sequentially assigning each of the plurality of carriers in each time slot to one of the plurality of users comprises:
for each carrier c at each time slot, selecting a user i which maximizes Wᵢ^{s} min{r(i,c),Qᵢ^{c}}, wherein Wᵢ^{s} denotes the weight for user i at the start of the frame, r(i,c) denotes the channel rate for the carrier c and the user i at the start of the frame, Qᵢ^{c} denotes the queue size of user i after carrier c services user i, and Qᵢ^{c+1}=max{0,Qᵢ^{c}−r(i, c)}.

7. The method of claim 5, wherein said step of sequentially assigning each of the plurality of carriers in each time slot to one of the plurality of users comprises:
for each carrier c at each time slot, selecting a user i which maximizes Wᵢ^{c} min{r(i,c),Qᵢ^{c}}, wherein r(i,c) denotes the channel rate for the carrier c and the user i at the start of the frame, Wᵢ^{c} denotes the weight for user i after carrier c services user i, Qᵢ^{c} denotes the queue size of user i after carrier c services user i, and Qᵢ^{c+1}=max{0,Qᵢ^{c}−r(i,c)}.

8. The method of claim 3, wherein said step of assigning each of a plurality of carriers in each time slot of the frame to one of a plurality of users comprises:
for each user i:
assigning a number of bits b(i,c) from each carrier c based on the objection function:
$$max {\sum }_{c} ( max \{ 0 , {W}_{i}^{s} b ( i , c ) - β ( c ) \} )$$
subject to the constraints of:
$$b ( i , c ) \leq r ( i , c ) ∀ i , c$$
$${\sum }_{c} b ( i , c ) \leq {Q}_{i}^{s} ∀ i$$
where Wᵢ^{c} denotes the weight for user i at the start of the frame, Qᵢ^{s} denotes the queue size of user i at the start of the frame, β(c) denotes a benefit value that measures a benefit of a current assignment of a carrier c, and r(i,c) denotes the channel rate for the carrier c and the user i at the start of the frame; and
updating the benefit value β(c) for each carrier based on the number of bits assigned to the user.

9. The method of claim 1, further comprising:
redistributing the carriers assigned to each user over the time slots of the frame to smooth service provided to each user.

10. The method of claim 9, wherein said step of redistributing the carriers assigned to each user over the time slots of the frame comprises:
for each user, evenly distributing tokens for each carrier and shifting tokens for all carriers assigned to the user by a random amount; and
sequentially assigning each of the tokens of all of the users of a time slot.

11. The method of claim 1, wherein said frame has a length of one time slot.

12. A computer-readable medium storing a computer-readable program of instructions for performing a method of operating a multi-carrier wireless data system for scheduling wireless data in a frame comprising one or more time slots, the instructions comprising:
assigning each of a plurality of carriers in each time slot of the frame to one of a plurality of users based on a weight for each user and a channel rate of each carrier for each user.

13. The computer-readable medium of claim 12, wherein the weight of one of the users is the queue size of the one of the users

14. The computer-readable medium of claim 12, wherein said step of assigning each of a plurality of carriers in each time slot of the frame to one of a plurality of users involves optimizing an objective function.

15. The computer-readable medium of claim 14, wherein said step of assigning each of a plurality of carriers in each time slot of the frame to one of a plurality of users comprises:
for each carrier c at each time slot, selecting a user i which maximizes Wᵢ^{s} min{(i,c),Qᵢ^{c}}, wherein Wᵢ^{s} denotes the weight for user i at the start of the frame, r(i,c) denotes the channel rate for the carrier c and the user i at the start of the frame, Qᵢ^{c} denotes the queue size of user i after carrier c services user i, and Qᵢ^{c+1}=max{0, Qᵢ^{c}−r(i,c)}.

16. The computer-readable medium of claim 14, wherein said step of assigning each of a plurality of carriers in each time slot of the frame to one of a plurality of users comprises:
for each carrier c at each time slot, selecting a user i which maximizes Wᵢ^{c} min{(i,c),Qᵢ^{c}}, wherein r(i,c) denotes the channel rate for the carrier c and the user i at the start of the frame, Wᵢ^{c} denotes the weight for user i after carrier c services user i, Qᵢ^{c} denotes the queue size of user i after carrier c services user i, and Qᵢ^{c+1}=max{0,Qᵢ^{c}r(i,c)}.

17. The computer-readable medium of claim 14, said step of assigning each of a plurality of carriers in each time slot of the frame to one of a plurality of users comprises:
for each user i:
assigning a number of bits b(i,c) from each carrier c based on the objection function:
$$max {\sum }_{c} ( max \{ 0 , {W}_{i}^{s} b ( i , c ) - β ( c ) \} )$$
subject to the constraints of:
$$b ( i , c ) \leq r ( i , c ) ∀ i , c$$
$${\sum }_{c} b ( i , c ) \leq {Q}_{i}^{s} ∀ i$$
where Wᵢ^{c} denotes the weight for user i at the start of the frame, Qᵢ^{s} denotes the queue size of user i at the start of the frame, β(c) denotes a benefit value that measures a benefit of a current assignment of a carrier c, and r(i,c) denotes the channel rate for the carrier c and the user i at the start of the frame; and
updating the benefit value β(c) for each carrier based on the number of bits assigned to the user.

18. The computer-readable medium of claim 12, the instructions further comprising:
redistributing the carriers assigned to each user over the time slots of the frame to smooth service provided to each user.

19. The computer-readable medium of claim 18, wherein said step of redistributing the carriers assigned to each user over the time slots of the frame comprises:
for each user, evenly distributing tokens for each carrier and shifting tokens for all carriers assigned to the user by a random amount; and
sequentially assigning each of the tokens of all of the users of a time slot.

20. An apparatus in a multi-carrier wireless data system for scheduling wireless data in a frame comprising one or more time slots, comprising:
means for assigning each of a plurality of carriers in each time slot of the frame to one of a plurality of users based on a weight for each user and a channel rate of each carrier for each user.

21. The apparatus of claim 20, wherein said means for assigning each of a plurality of carriers in each time slot of the frame to one of a plurality of users comprises:
means for assigning each of the plurality of carriers in each time slot of the frame to one of the plurality of users such that the carriers assigned to each of the plurality of users are not excessive with respect to a queue size of the user.

22. The apparatus of claim 20, wherein said means for assigning each of a plurality of carriers in each time slot of the frame to one of a plurality of users comprises:
means for sequentially assigning each of the plurality of carriers in each time slot to one of the plurality of users, such that each of the plurality of carriers is assigned to a user for which an objective function is maximum, wherein said objective function is based at least in part on an adjusted value of a queue size of a user based on an assignment of a carrier to that user.

23. The apparatus of claim 20, further comprising:
means for redistributing the carriers assigned to each user over the time slots of the frame to smooth service provided to each user.
